(19) United States
(12) Patent Application Publication
(10) Pub. No.: US 2018/0164204 A1
(43) Pub. Date: Jun. 14, 2018

(54) METHOD FOR ESTIMATING SERVICE LIFE OF FILTER GAUZE

(71) Applicant: Aether Services, Taiwan, Ltd., Hsinchu City (TW)

(72) Inventors: Jui-Pin Wu, Hsinchu City (TW); Chun-Yuan Lee, Hsinchu City (TW); Chen-Chia Tsai, Hsinchu City (TW); Ying-Peng Wu, Hsinchu City (TW)

(21) Appl. No.: 15/833,278

(22) Filed: Dec. 6, 2017

Related U.S. Application Data
(60) Provisional application No. 62/432,774, filed on Dec. 12, 2016.

(51) Int. Cl. G01N 15/08; B01D 46/00

(52) U.S. Cl. CPC G01N 15/082; G01N 15/088; B01D 46/0086

(57) ABSTRACT

The method for estimating a service life of a filter gauze in this application is applicable to an air cleaner. The method includes: calculating a relationship between an outlet air velocity, a rotational speed, and a blocking ratio of the filter gauze; and estimating a remaining service life of the filter gauze. In this way, a user can be more accurately informed of a remaining service life of a filter gauze, and instructed to change the filter gauze at a most appropriate time.

### BACKGROUND

### Technical Field

The present invention relates to a method for estimating a service life of a filter gauze, and in particular, to a method, applicable to an air cleaner, for estimating a service life of a filter gauze. In this way, a user can be more accurately informed of a remaining service life of a filter gauze of a cleaner, and instructed to change the filter gauze of the cleaner at a most appropriate time.

### Related Art

Currently, for most air cleaners on the market, a remaining service life of a filter gauze is calculated based on a fixed timer, that is, the remaining service life of the filter gauze is estimated only according to a running time, regardless of air quality and an operating speed. This calculation method is simple, but the filter gauze is usually changed too early or too late.

### SUMMARY

An objective of the present invention is mainly to provide a method, applicable to an air cleaner, for estimating a service life of a filter gauze. A remaining service life of the filter gauze of a cleaner is calculated by using air quality sensed by a sensor and an operating speed of a fan of the cleaner, and a user is instructed to change the filter gauze of the cleaner at a most appropriate time.

The method for estimating a service life of a filter gauze in the present invention is applicable to an air cleaner, comprising: calculating a relationship between an outlet air velocity, a rotational speed, and a blocking ratio of the filter gauze; and estimating a remaining service life of the filter gauze.

### BRIEF DESCRIPTION OF THE DRAWINGS

FIG. 1 is steps S100 to S130 showing a method for estimating a service life of a filter gauze.

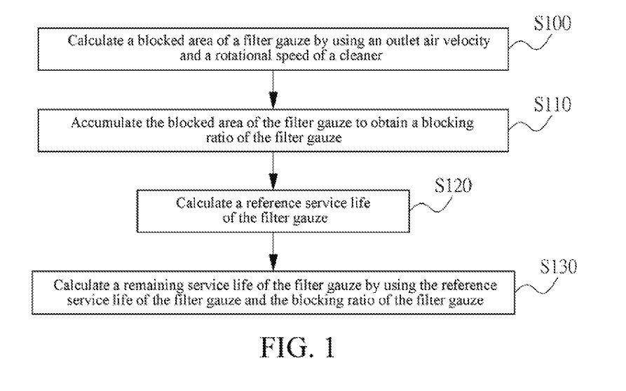

### DETAILED DESCRIPTION

To further understand the objective, structural features and functions of the present invention, descriptions are provided in detail with reference to the related embodiment and FIGURE as follows:

When air including particles passes through a filter gauze, most of the particles are netted or absorbed by the filter gauze. For a general E11 filter gauze, more than 95% of the particles are netted, and only less than 5% of the particles pass through the filter gauze.

After the filter gauze nets the particles, pores on a cleaner material for particles to pass through become fewer, and fewer particles pass through the filter gauze. However, an outlet air velocity V of a cleaner becomes smaller, and consequently total amount of air that can be filtered per hour (CADR) by the filter reduces. Once an actual value of the CADR of the filter, that is, CADR-t, reduces to below a remaining ratio P (0<P<1) of CADR-r, that is, a original value of the CADR, it is suggested that a user should change the filter gauze.

The foregoing outlet air velocity is in positive correlation with a value of the CADR.

The foregoing outlet air velocity V is in positive correlation with a cleaner rotational speed R, and is in negative correlation with a blocking degree of the filter gauze. First, step S100: calculate a relationship between an outlet air velocity, a rotational speed, and a blocking ratio of a filter gauze. The following formulas represent the relationship between the outlet air velocity, the rotational speed R, and the blocking ratio of the filter gauze:

v(i)=k1*r(i)*[1−b(i)] —formula 1

r(i) is the rotational speed of a motor fan at a time point i; b(i) is the blocking ratio of the filter gauze at the time point i, where 0<b(i)<1; and k1 is a ratio of the outlet air velocity to the rotational speed of the fan, and is assumed to be a constant. When particles of air pass through the filter gauze, the particles are netted by the filter gauze. If a particle concentration at this time is c(i), the outlet air velocity of the filter is v(i), an operating time in this state is t(i), and an area of a blocked part of the filter gauze is:

a(i)=k2*c(i)*v(i)*t(i) —formula 2,
where k2 is a transform coefficient and is assumed to be a constant, and the following may be obtained by substituting v(i) in formula 2 with formula 1:

a(i)=k1*k2*c(i)*r(i)*[1−b(i)]*t(i) —formula 3

Subsequently, step S120: Accumulate all the blocked areas to obtain a blocking ratio b(n):

b(n)={a(1)+ . . . +a(n−1)}/A=Σᵢ₌₁ⁿ⁻¹a(i)/A —formula 4,
where A is a total area of the filter gauze.

When the filter gauze is new and the rotational speed of the fan is fixedly R, the outlet air velocity is V1. The rotational speed R remains unchanged, and when a value of the CADR reduces to P×CADR, it can be measured that the outlet air velocity is V2. It can be learned from formula 1 that k1 may be expressed as:

k1=V1/R —formula 5

In a laboratory, particles with a fixed concentration C may be placed on a filter gauze to be measured, and the rotational speed of the fan of the cleaner is fixedly set to R, to measure a time T required for the value of the CADR of the cleaner to reduce to P×CADR-r.

Because R remains unchanged and V slightly reduces linearly in this process, an average air velocity Vavg is used to represent the air velocity in this process:

Vavg=(V1+V2)/2.

Subsequently, step S120 is performed, and it can be learned from formula 2 that the reference service life T is:

T=A*(1−P)/(C*Vavg*k2).

C and A can be controlled, and T, V1 and V2 can be obtained by measurement. Therefore, k2 can be expressed as:

k2=2*A*(1−P)/[C*T*(V1+V2)].

The following can be obtained by substituting k1 and k2 in formula 3 with numerical values of k1 and k2:

$$a ( i ) = \frac{2 A ( 1 - P ) V 1}{CRT ( V 1 + V 2 )} c ( i ) r ( i ) [ 1 - b ( i ) ] t ( i ) \qquad formula 6$$

It is assumed that there are n time periods from a time when the filter gauze starts to be used to a present time, and a sum of all the time periods is t. In step S130, a remaining service life tr of the filter gauze may be estimated as:

tr={[A−Σᵢ₌₁ⁿa(i)]/Σᵢ₌₁ⁿa(i)}*t —formula 7

The following is an embodiment of the present invention.

It is assumed that a total area of a filter gauze is that A=10 m². When C=15 μg/m3, R=400 rpm, V1=0.9 m/s, V2=0.45 m/s, and P=0.5, it is measured that T=4000 hours.

Parameters related to the filter gauze from the time when the filter gauze starts to be used to a time are recorded as follows:

TABLE 1

| | Time period length | Particle concentration | |
|---|---|---|---|
| Time period i | (hours) | (μg/m3) | r (rpm) |
| 1 | 3 | 10 | 400 |
| 2 | 0.5 | 40 | 700 |
| 3 | 0.3 | 60 | 1000 |
| 4 | 6.2 | 15 | 400 |
| 5 | 8 | 15 | 0 |
| 6 | 6 | 10 | 400 |

In formula 6, a front constant ka==2*10*(1−0.5)*0.9/(15*400*4000*(0.9+0.45))=0.0000002778.

| | | | Rotational | | | |
|---|---|---|---|---|---|---|
| | Time period | Particle | speed r (rpm) | | | Accumulated |
| Time | length | concentration c | of a motor | b(i) | a(i) | blocked area |
| period i | (hours) | (μg/m3) | of a fan | Formula 4 | Formula 6 | a(1) + . . . + a(i) |
| 1 | 3 | 10 | 400 | 0.000000 | 0.003333 | 0.003333 |
| 2 | 0.5 | 40 | 700 | 0.000333 | 0.003888 | 0.007221 |
| 3 | 0.3 | 60 | 1000 | 0.000722 | 0.004996 | 0.012217 |
| 4 | 6.2 | 15 | 400 | 0.001222 | 0.010321 | 0.022538 |
| 5 | 8 | 15 | 0 | 0.002254 | 0.000000 | 0.022538 |
| 6 | 6 | 10 | 400 | 0.002254 | 0.006652 | 0.029190 |

By means of formula 7, it is estimated that the remaining service life of the filter gauze is tr=(10−0.029190)/0.029190*24=8198 (hours).

For brevity, only the six time periods are calculated. Actually, in the time periods, b(i) is a variable that becomes larger as a filtering time increases. For brevity herein, b(i) remains as a constant in the time periods, and this is just for facilitating calculation. The time periods should be divided into smaller time periods, for example, each second is a time period, so that an error of an operation result is relatively small.

In comparison, if calculation is performed by using a conventional countdown method, the remaining service life of the filter gauze is estimated as:

tr′=4000−running time=4000−16=3984 (hours).

In the conventional countdown method, a remaining running time before the filter gauze needs to be changed is informed, regardless of air quality and a rotational speed of a fan. According to the method provided in this patent, a user can be more accurately informed of a remaining service life of a filter gauze, and instructed to change the filter gauze at a most appropriate time.

In conclusion, the foregoing descriptions are only intended to record the implementations or embodiments of technical means used to resolve the problems in the present creation, but are not intended to limit the implementing scope of the of the present creation. That is, any equivalent changes and modifications consistent with the meaning within the application scope of the present creation or made according to the scope of the present creation shall fall within the scope of the present creation.

What is claimed is:

1. A method for estimating a service life of a filter gauze, wherein the method is applicable to an air cleaner, and comprises the following steps:
calculating a blocked area of the filter gauze by using an outlet air velocity and a rotational speed of the cleaner;
accumulating the blocked area of the filter gauze to obtain a blocking ratio of the filter gauze;
calculating a reference service life of the filter gauze; and
calculating a remaining service life of the filter gauze by using the reference service life of the filter gauze and the blocking ratio of the filter gauze.

2. The method for estimating a service life of a filter gauze according to claim 1, wherein r(i) is a rotational speed of the cleaner at a time point i;
b(i) is a blocking ratio of the filter gauze at the time point i;
c(i) is a particle concentration at the time point i;
v(i) is the outlet air velocity;
t(i) is an operating time;
v(i)=k1*r(i)*[1−b(i)], and
a(i)=k2*c(i)*v(i)*t(i), wherein
the blocked area of the filter gauze is:
a(i)=k1*k2*c(i)*r(i)*[1−b(i)]*t(i), wherein
k1 is a ratio of the outlet air velocity to a rotational speed of a fan, and k2 is a transform coefficient.

3. The method for estimating a service life of a filter gauze according to claim 2, wherein the blocking ratio of the filter gauze is:
b(n)={a(1)+ . . . +a(n−1)}/A=Σᵢ₌₁ⁿ⁻¹a(i)/A, wherein
A is a total area of the filter gauze.

4. The method for estimating a service life of a filter gauze according to claim 2, wherein k1=V1/R, and when the filter gauze is new and the rotational speed of the cleaner is fixedly R, the outlet air velocity is V1.

5. The method for estimating a service life of a filter gauze according to claim 4, wherein when a value of a total amount of air that can be filtered per hour (CADR) reduces to a remaining ratio P×CADR, it can be measured that the outlet air velocity is V2, and
an average air velocity Vavg=(V1+V2)/2, wherein
when a filter gauze to be measured is provided with a particle concentration of C, a time required for the value of the total amount of the air that can be filtered per hour (CADR) by the air cleaner to reduce to a remaining ratio P×CADR-r is a reference service life T of the filter gauze.

6. The method for estimating a service life of a filter gauze according to claim 5, wherein the reference service life T of the filter gauze is:
T=A*(1−P)/(C*Vavg*k2), wherein
k2 can be expressed as:
k2=2*A*(1−P)/[C*T*(V1+V2)].

7. The method for estimating a service life of a filter gauze according to claim 6, wherein the remaining service life of the filter gauze is:
tr={[A−Σᵢ₌₁ⁿa(i)]/Σᵢ₌₁ⁿa(i)}*t, wherein
$$a ( i ) = \frac{2 A ( 1 - P ) V 1}{CRT ( V 1 + V 2 )} c ( i ) r ( i ) [ 1 - b ( i ) ] t ( i ) .$$
